(19) United States
(12) Patent Application Publication
(10) Pub. No.: US 2008/0114663 A1
(43) Pub. Date: May 15, 2008

(54) PRODUCT RESALE SYSTEM AND METHOD

(75) Inventors: Richard Watkins, Chula Vista, CA (US); Jim Franco, El Cajon, CA (US)

Correspondence Address: KNOBBE MARTENS OLSON & BEAR LLP, 2040 MAIN STREET, FOURTEENTH FLOOR, IRVINE, CA, 92614, US

(73) Assignee: Charitable Auto Resources, Inc., San Diego, CA (US)

(21) Appl. No.: 11/933,286

(22) Filed: Oct. 31, 2007

Related U.S. Application Data
(60) Provisional application No. 60/855,827, filed on Nov. 1, 2006.

(51) Int. Cl. G06Q 30/00; G06Q 40/00

(52) U.S. Cl. 705/26; 705/35; 705/30

(57) ABSTRACT

This invention includes systems and methods for processing charitable donations. One embodiment includes a web based system adapted capture information related to the items for charitable donation, assigning at least one charitable organization to receive a benefit of the donated item, monitoring and updating the status of the item for resale, processing the item for resale by an entity identified by the system, capturing the monetary value and expense date related to selling the item, and providing the charitable organization access to the donation data including the monetary value and expense data captured by the system.

### CROSS-REFERENCE TO RELATED APPLICATIONS

This application claims the benefit of U.S. Provisional No. 60/855,827 filed Nov. 1, 2006.

### BACKGROUND OF THE INVENTION

1. Field of the Invention

The present invention is related to a product resale system and method, more particularly, a web-based charitable donation system and method.

2. Description of the Related Art

Every year thousands of automobiles are donated to charitable organizations. Some people drop off the automobile to a designated donation site, and the automobile is later sold. In other cases, the automobile owner contacts a charity that will accept a auto donation, and the charity arranges for the automobile to be picked-up by an automobile delivery company and sold by an external entity. In either case, there is little, if any, transparency for the car donor or charity to view the status of the auto sale, how much it was sold for, or the expenses required to facilitate the sale (e.g., delivery by towing, pre-sale cleaning or repair, auction house commission and fees, etc.) that affect the financial benefit received by the charity. In yet other scenarios, a third party may be involved in facilitating the charitable transaction. Private and sensitive information, such as social security numbers provided for tax purposes, may also be compromised by charitable donation systems, if the private information is not properly protected by access permissions or encryption algorithms. In such cases, both the donor and charity may have little or no access to the information regarding the status of the auto sale, how much the automobile donation was actually sold for, the expenses required to facilitate the sale, or other information related to the automobile donation process, or be confident that their private information is kept private. In addition, the tax forms that are required to deduct a donated automobile can be confusing for donors and charitable organizations to understand and manage. Accordingly, a system and method for overcoming these and other deficiencies, and for coordinating aspects of the automobile donation process is needed.

### SUMMARY OF THE DISCLOSURE

The present invention comprises a system and method for processing a charitable donation for resale.

One embodiment includes a method of processing a charitable donation where an item is acquired for charitable donation from a donor. The item is associated with a donation record containing donation data relating to the item. The donation data includes information relating to which charitable organizations are selected to receive a monetary benefit from the sale of the donated item. The monetary benefit that the charitable organizations receive related to the item may be equal to the sale price of the item less any expenditure associated with the sale of the donated item. The sale price of the donated item may be designated as the monetary value of the donated item. Moreover, the expense data related to selling the item includes any expenditure for preparing the item for sale. The donation data may include any expense data and a monetary value of the item. Charitable organizations may have access to at least some of the donation data including the monetary value and any expense data related to the donated item. Moreover, charitable organizations have access to view accounting of any donated items assigned to that specific charitable organization. The charitable organizations are provided access to the donation data using an interface utilizing a username and a password assigned to the charitable organization. Typically, the charitable organizations are provided access using a web interface to view any transactions assigned to that particular charitable organization.

In another embodiment, a machine readable medium has instructions for processing a charitable donation, where the instructions upon execution cause a machine to identify at least one item for charitable donation from a donor and track the acquisition of the item. The instructions further cause a machine to associate the item with a donation record containing donation data relating to the item. The donation data includes information relating to which charitable organizations are selected to receive a monetary benefit from the sale of the donated item. The monetary benefit the charitable organizations receive related to the item may be equal to the sale price of the item less any expenditure associated with the sale of the donated item. The sale price of the donated item may be equal to the monetary value of the donated item. Moreover, any expense data related to selling the item includes any expenditure for preparing the item for sale. The donation data may include any expense data and a monetary value of the item. Charitable organizations have access to the donation data including the monetary value and any expense data related to the donated item. Also, charitable organizations have access to any donated items assigned to that specific charitable organization. The machine readable medium can have instructions to allow the charitable organizations access to the donation data using an interface utilizing a username and a password assigned to the charitable organization. The charitable organizations are provided access to view any transactions assigned to that particular charitable organization.

In another embodiment, a system, having a storage medium to store information and an application logic executing on a processor, is configured to provide a charitable organization access to examine transaction data including any expenses for selling a donated item, a sales price of a donated item and a status of a donated item. A donated item may be assigned to at least one charitable organization for monetary benefit. Moreover, an expense for selling a donated item may be a sale fee or a delivery fee. The donated item may be an automobile. The status of the donated item may be used to determine the donated item state in the system. The system may allow a username and a password to be used to access the system from a remote computer using a web interface. The sale price less any expense associated with the donated item may be used to determine the net sale revenue being designated to at least one charitable organization.

In another embodiment, a machine readable medium having instructions, where the instructions upon execution cause a machine to receive at least one item information regarding at least one item for resale from a first entity, monitor a status of the item for resale, identify a second entity for processing the item for resale. The instructions can further cause the machine to update the status of at least one item for resale based at least in part on the processing of the item for resale, maintain data relating to a sale of the at least one item for resale, and provide access to the at least one item information received from a first entity. The first entity and the second entity can be granted permission to modify data in the system. Moreover, the first entity and second entity can be allowed access using a web interface to view and modify the item information maintained by the system.

Neither this summary of the disclosure nor the following detailed description purports to define the invention. The invention is defined by the claims.

### BRIEF DESCRIPTION OF THE DRAWINGS

These and other features will be described with reference to the drawings summarized below. These drawings and the associated description are provided to illustrate a preferred embodiment of the invention, and not limit the scope of the invention.

FIG. 1 illustrates a network accessible computer system according to one embodiment of the invention.

FIG. 2 illustrates a system architecture diagram according to one embodiment of the invention.

FIG. 3 illustrates a product record in accordance with one embodiment of the invention.

FIG. 4 illustrates a flow diagram of an exemplary method described in accordance with one embodiment of the invention.

FIG. 5 illustrates a low level flow diagram of an exemplary method described in accordance with one embodiment of the invention.

### DETAILED DESCRIPTION OF CERTAIN EMBODIMENTS

Specific embodiments of the invention will now be described with reference to the drawings. These embodiments are intended to illustrate, and not limit, the present invention. For example, although the specific embodiments described herein involve an automobile donation system and method, the invention is also applicable to other types of product acquisition and resale actions, including homes, boats, motorcycles, or any item applicable to a re-sale to generate a monetary value for the benefit of an entity other than the products' original owner.

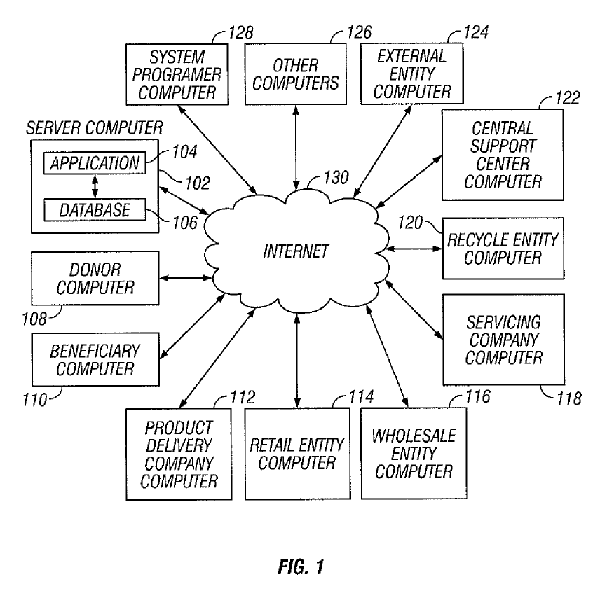

FIG. 1 illustrates a network accessible computer system according to one embodiment of the invention. The server computer 102 includes a database 106 and an application logic 104 that generates and serves pages of a web site to computing devices requesting data from the server computer 102. The server computer 102 may be accessible by a plurality of external entities' computers by means of a network connection, for example, an Internet connection, either through wired or wireless communication, to obviate the need for the system to be co-located at any physical site for connectivity and access.

The server computer 102 may be configured to host and provide a website associated with a central support center, which allows access to information and processes associated with donating a car to a charity. The server computer 102 may provide functionality implemented on the web page displaying a variety of information to external users including, for example, information describing how to donate a car, how to start a car donation program, charities supported by the central support center, answers to frequently asked questions, instructional manuals, testimonials from donors, and means to contact the central support center by means of telephone communication, facsimile communication, web forms, or an email address. Moreover, the website provides access to a sales presentation intended to attract external charities and external vendors. Also, the website provides a medium to facilitate the communication between external charities and vendors into becoming partner charities and authorized vendors. The web-site is configured to provide a web-page that includes a web-form, an E-mail, a business address, and a phone number may be utilized to provide contact means to the central support center to help generate external charities into becoming partner charities. In much the same way, a web-page that provides a web-form, an E-mail, a business address, and a phone number may be utilized to provide contact means to the central support center to help generate new external vendors into becoming authorized vendors. New external vendors that are chosen into becoming members can be required to provide at least one credit card on file to be used in cases of non-payment or other billing concerns.

The server computer 102 including the application logic 104 and the database 106 may be licensed to a plurality of external users for personal business use. For example, the server computer 102 coupled with the application logic 104 and the database 106 may be licensed to an organization that operates its own charitable automobile donation program or a donation program for other goods. Moreover, product delivery companies or other external businesses, may acquire a license to use resources of the server computer 102, including the application logic 104 and the database 106 that is completely separate and customized to fit the specific needs of their business without sharing data intended for the central support center.

The application logic 104 communicates with the database 106, which stores all the information associated with a car donation in the server computer 102. The database 106 may be a structured query language (SQL) relational database residing within the server computer 102 and located in secure location. The database 106 may implement T-SQL, PL/SQL, Sqsh, SQL, SQL/PSM, SQL PL, MySQL, PL/pgSQL, or other alternative structured query language standards. As one of skill in the art will appreciate, other types of databases and other schemes of data storage may also be used. The database 106 may comprise a plurality of database tables and fields to capture data intended for storage by the database and retrieval by the application logic 104. However, specific fields of the database 106 may be designated as required fields mandating information be entered in such designated field during the use of the system, thus ensuring the completeness of the database. Also, certain fields may be partially or fully encrypted, set to display only a portion of the entered information, or restricted access of information to ensure sensitive information is kept private. The database 106 may be configured to store all the information required to track a vehicle through the donation process. Accessing the database 106 on the server computer 102 provides real-time status of each donation.

The server computer 102 may be located in a secure facility that includes information technology services such as emergency backup power, routine data backup, and data storage on random array of inexpensive discs (RAID) devices to minimize the risk of data loss. The server computer 102 provides functionality to a user, with the proper access privileges, to query, sort, display and print reports from the information stored in the database 106. The server computer 102 restricts access to external users by requiring a username and a password to enter the system. General information may be provided without access restrictions. To ensure system security, access permissions may further be restricted to IP filtering, for example, only granting access to any specific user of the system from a specific IP address. The system may be configured to associate a username with certain privileges and allow a user access to certain information and functionality, customized to fit the user's intended purpose in utilizing the server computer 102.

The application logic 104 may be comprised of a plurality of computer programming and computer interface languages, including XHTML 1.0, ASP.NET, C#, NET 1.1, and JavaScript. As one of skill in the art will appreciate, other types of programming and interface languages, for example, C, C++, APN.NET 2.0, Visual Basic .NET 2.0, Java, HTML, may be utilized to create the same functionality captured in the application logic 104 of the server computer 102.

The server computer 102 may be accessed by a first entity such as donor computer 108 to input information relating to a donation of an automobile, or more generally any product, to be sold for the benefit of a charitable organization. Moreover, a donor computer 108 may require access to the server computer 102 to view any transactions, monitor the status, and receive tax reporting documentation related to a donation made using the system. Donors desiring to donate an automobile from a particular charity web page are seamlessly redirected into the system using a web link which produces an online donation form that is intended to the server computer 102 upon completion and submission.

The server computer 102 may be accessed by a second entity such as a product delivery company computer 112, for example, a tow truck company, to access information relating to automobiles pending for delivery and to update the status and fees associated with automobile that have been successfully delivered to the destination addresses. Moreover, a product delivery company 112 may access information relating to donations that are scheduled for pick-up, including vehicle address, delivery address, contact name, car information, date and time for pick-up, and any other information required to successfully pick-up a donated vehicle and deliver it to the designated dealer, salvage yard, or auction house.

The server computer 102 may be accessed by a third entity such as beneficiary entity computer 110, for example, a non-profit charitable organization, to monitor the status of donations from donors in the system, for example, the access may be used to view sales expenses, access accounting modules to validate accounting of revenue, and generate customized reports. The server computer 102 may be accessed by multiple charitable organizations. The server computer 102 may be configured to keep segregated information regarding each charitable organization respective car donation program. Thus, the system creates a virtual marketplace of car donation services with a plurality of charitable organizations participating and receiving proceeds from car donations made and processed in their respective names. The server computer 102 may be configured to allow each charitable organization access to their respective portion of the database 106 and review information including the donors information, donation records, status of donations, and proceeds (or revenue) associated with their respective car donation program.

The server computer 102 also maintains information regarding participating product delivery companies and is able to match a product delivery company to the physical location of the item for donation. The server computer 102 or the central support center 212 may then schedule a respective product delivery company to provide product pick-up and delivery and communicate the appointment to the product delivery company by means of electronic communication or facsimile communication. In some embodiments, the information is accessible to the product delivery company through a database. In some embodiments, queries (often using pre-set queries for ease of use) may be provided in a report format, generated by the product delivery company or the report can be provided to the product delivery company. The product delivery companies can print individual reports (listing on a single page all the information associated with a single pick-up) directly from the interface so that they can be distributed to individual responsible for delivery of the automobile. If a product delivery company does not have access to the web-based interface, an employee at the central support center can generate the applicable reports and fax (or email) it to the product delivery company. In some cases, car dealers, salvage yards, or auction houses have their own auto delivery capabilities in which case they can either print out the delivery listing or it can be emailed or faxed to them by the central support center. Once a car is picked up, the status of the car can be entered into the database via the web page by either the car delivery company or the central support center, and all parties associated with that particular car donation can have access to its status in real-time via the website.

The server computer 102 may be accessed by a fourth entity such as wholesale entity computer 116, for example, a wholesale automobile auction dealer, to access reports relating to automobiles assigned for a wholesale auction, and to update the status and fees associated with the automobiles that have been successfully sold by the wholesale entity. The server computer 102 may be accessed by a servicing company computer 118, for example, a mechanic shop, to access reports relating to automobiles pending service requests, and to update the status and fees associated with the automobiles that have been serviced by the assigned servicing company.

The server computer 102 may be accessed by a fifth entity such as recycle entity computer 120, for example, an automobile salvage yard, to access reports relating to automobiles pending recycling requests, and to update the status and fees associated with the automobiles that have been recycled by the assigned recycling company.

The server computer 102 may also be accessed by a fifth entity such as central support center computer 122, for example, a central support center, to process new donor donation requests and update any pending donor requests in the system. The central support center computer 122 may generate donor reports, accounting reports, sales reports, delivery reports, servicing reports, and other reports capable of being generated by the system. The server computer 102 may be accessed by a system programmer computer 128, to allow support and maintenance functions to be performed remotely at any time.

The server computer 102 may also be accessed by an external entity computer 124 to gain access to system functionality. Also, the server computer 102 may be accessed by a plurality of other computers 126 wherein customized permissions or access controls are provided by the system to limit the use of functions available on the system. Appropriate access to the server computer 102 by a plurality of external entities described in FIG. 1 allows transparency to each aspect of the donation process including tracking of the expenses. Generally, the server system 102 stores in the database 106 all expenses associated with the donation including, towing, smog check, paint washing, DMV, escrow, charity revenue, etc. The transparency allows all plurality of external entities accessing and using the system to be involved and able to view financial transactions associated with donations captured within the system, facilitating a more trusting environment which in turn facilitates more donations.

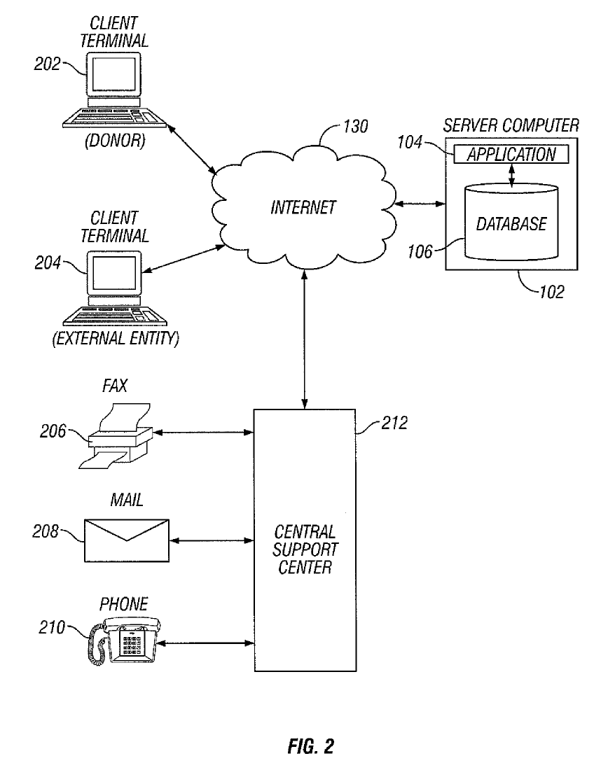

FIG. 2 illustrates a system architecture diagram according to one embodiment of the invention. FIG. 2 displays the architecture utilized to facilitate initial donor contact with the server computer 102. First and foremost, the server computer 102 includes a database 106 and an application logic 104 that generates and serves pages of a web site to computing devices requesting data from the server computer 102. The server computer 102 may be accessible by a plurality of external entities. The server computer 102 may be accessed by a donor client terminal 202, for example, by use of a web form, to input information relating to a donation of an automobile to be sold for the benefit of a charitable organization. Also, the donor client terminal 202 may submit an electronic email communication to the central support center providing information regarding a car donation. Moreover, the server computer 102 may be access by external client entity 204, for example, a non-profit charitable organization, to view new automobile donations captured by the system.

Donors may wish to interface with the system to provide automobile donation information by facsimile transmission 206, regular mail 208 or by phone 210. Donation requests received by facsimile transmission 206 are forwarded to the central support center 212, after initial review of the application provided by the donor, an employee of the central support center 212 will contact the donor to request detail information from the donor regarding the automobile donation. In much the same way, if a donor utilizes regular mail 208 as a means to donate an automobile, the letter sent via regular mail will be reviewed and an employee of the central support center 212 will contact the donor to request detail information from the donor regarding the automobile donation to be inputted into the server computer 102. Moreover, the phone calls 210 generated from a donor are programmatically routed to employee of the central support center 212 and they are answered on behalf of the participating charitable organizations participating in the automobile donation system. The central support center employees record new donations and update existing donations in the system by accessing the remote server computer 102 by means of a network connection, for example, an Internet connection 130 to request and receive information in real-time.

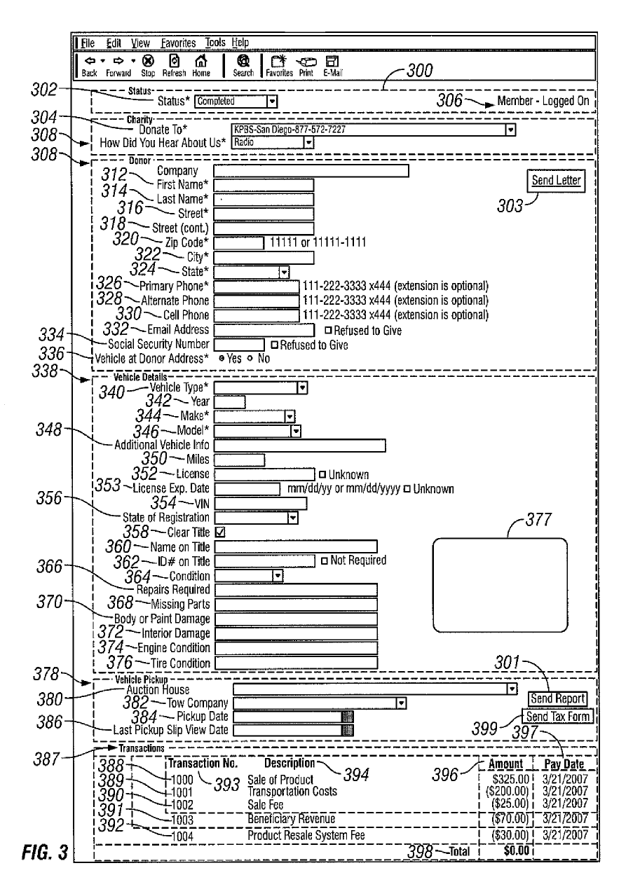

FIG. 3 illustrates a product record in accordance with on embodiment of the invention. FIG. 3 displays an exemplary automobile donation record 300 in the auto donation system. The automobile donation record 300 is typically maintained by the central support center and may be modified by a plurality of external entities, given access permissions. The automobile donation record 300 displays a status 302 that may be modifiable by the central support center, wherein the status may be set to “incomplete,” “title issue,” “new donation,” “collections,” “evaluating,” “awaiting lien sale,” “awaiting pick-up,” “scheduling,” “awaiting repair,” “awaiting sale,” “cancelled at door,” “awaiting check,” “completed,” “faxing,” “cancelled,” “declined,” “inactivity cancellation.”. The system maintains a plurality of automobile donation records and monitors the status of donation records stored in the system. The status is typically manually updated, but the system is configured to allow systematic or automatic status updates of automobile donation records stored in the system as the donated items are processed by the system.

Status 302 or state information as defined by the system is now provided. A status of “incomplete” may be set to a donation record missing information before a pick-up is scheduled, for example, vehicle location, title number, vehicle identification number may be missing from a record provided by a donor. A status of a “title issue” may be set to a donation record waiting for a vehicle title to clear due to a lien currently pending at the department of motor vehicles, in other words, waiting for a clear title status from the DMV. Also, a status of “title issue” may be set to a donation record where a duplicate title request has been submitted to the department of motor vehicle. A status of a “new donation” may be accessed by the central support center manager to facilitate the routing of the donation to an external entity, such as an auction house, salvage yard, or retail sales vendor. A status of “collections” may be set to a donation record where an external entity, for example, an auction wholesale dealer or a retail dealer, has verified possession of a vehicle but have not yet processed payment to the central support center; or when the external entity has shown its inability to pay in excess of thirty days from the date of sale.

A status of “evaluating” may be set to a record where a donor may be requesting to donate a vehicle to a non-participating organization and the vehicle has not yet been routed for pick-up by an external entity. Also, a status of “evaluation” may be set to a donation record where the central support center may be in the process of determining a resale channel to be selected for a particular donated item. Furthermore, a status of “evaluating” may be set to a donation record where a particular donated item is being evaluated for repair or reconditioning needs. A status of “awaiting lien sale” may be set to a record where a lien sale may be required to obtain title of a donated vehicle. A status of “awaiting lien sale” may be set to a record awaiting permission from the department of motor vehicles for a lien sale. The department of motor vehicles typically sends inquiry requests to last three previous owners of the vehicle to obtain information relating to any ownership interest in the vehicle. A status of “awaiting pick-up” may be set to a record to mean that the vehicle donation information has been routed to an external entity, for example an automobile delivery company, where the record can be viewed and the donation may be available for pick-up. A status of “scheduling” may be set to a record where the central support center has selected to schedule a specific date and time for the vehicle donation to be picked up. A status of “awaiting repair” may be set to a record where the central support center makes a determination to schedule maintenance or repair before a sale and may be waiting for servicing to be complete.

Moreover, a status of “cancelled at door” may be set to a record where an external entity, such as a product delivery entity, arrives to the vehicle location to realize that the donor has cancelled the request to donate the vehicle. The status of “cancelled at door” may be set to a record where the central support center may wish to contact the product donor to verify the cancellation of a vehicle upon arrival of a product delivery company to alleviate any suspicion of theft by a product delivery company. A status of “awaiting check” may be set to a record where a vehicle has been confirmed to be sold by an external selling entity, and the central support center may be awaiting payment from the sale. A status of ‘completed” may be set to a record when the entire donation process lifecycle has been completed. Furthermore, a status of “completed” set to a record may suggest that any and all correspondence intended to a donor and a beneficiary entity has been completed; including any tax documentation, letter correspondence, and records of sale. A status of “faxing” may be set to a record that may be waiting to be faxed to an external entity for pick-up.

A status of “cancelled” may be set to a record for multiple reasons, for example, where a donor changes their decision to donate their vehicle and calls the central support center back to request cancellation of donation. A status of “cancelled” could also be set to a record where the donor has donated the vehicle to an alternative product delivery company or was declined by the central support center due to failure to meet minimum qualification requirements set for product delivery to take place. A status of “declined” may be set to a record where the vehicle may be located in a remote location where it may not able to be picked up by a product delivery company. A status of “inactivity cancellation” may be set to a record where a donor has insufficient information to process a donation claim, or the donor has been non-responsive in scheduling a vehicle pick-up, and the donor has been contacted several times and has not called back with any further information. The status 302 may be available in a pending and a complete automobile donation record 300. The status 302 may be used by the automobile donation system to track the progress of an item in the system. The status 302 may be updated by many external entities to the system. The status 302 may be used in the reports mechanism of the automobile donation system to generate customized reports. Most importantly, the status 302 may be used by donors and charitable organizations to track the state of their respective donations.

The beneficiary organization 304, for example, a charitable organization may be associated with an automobile donation record 300. The beneficiary organization 304 may be assigned to receive the monetary benefit, or net revenue generated from the sale of the automobile, irrespective of the physical pick-up or sale location of the donated item. An automobile donation record 300 may designate more than one beneficiary organization 304. Moreover, the percentage of net revenue (not shown) assigned to each beneficiary organization 304 from the donation may be accounted for in the automobile donation record 300 if more than one beneficiary organization 304 is selected. Sourcing 308 may be utilized in the automobile donation record 300 to record how the donor heard about the car donation program. Sourcing 308 may be important for beneficiary charitable organizations 304 to track because it can help beneficiary organizations 304 analyze their current marketing strategy and customize future strategic marketing decision to lead to more automobile donations for their organization. The sourcing means supported by the system include Internet advertising, television advertising, radio advertising, magazine advertising, and word of mouth advertising by a previous donor or a friend/family.

Donor information 310 captured by the system may include first name 312, last name 314, street name 316, street name continued 318, zip code 320, city 322, state 324, primary phone 326, alternate phone 328, cell phone 330, email address 332. Moreover, the social security number 334 is captured, but is not required by the system, and may be encrypted by the system to only display the last four digits to prevent unauthorized access to this information.

Vehicle detail 338 captured by the system may include vehicle type 340, vehicle year 342, vehicle make 344, vehicle model 346, additional vehicle information 348, the number of miles 350 associated with the vehicle, driver license number 352 of the donor, driver license expiration date 353 of the donor, the vehicle identification number 354 of the vehicle being donated, state of registration 356 of the vehicle being donated, clear title 358 validation, name as it appears on the vehicle title 360, identification number on the title 362, condition 364 of the vehicle, repairs required 366 before pick-up or sale, missing parts 368 related to the vehicle being donated, body or paint damage 370, interior damage 372 to the vehicle, engine condition 374, tire condition 376, and an image 377 of the vehicle in electronic format.

Furthermore, the product donation record 303 may also include additional documentation associated with the donated item. A donation record may include a plurality of PDF or image formats of documents (not shown) received from the department of motor vehicles, in example, a title to a vehicle. A donation record may include PDF or image format of receipts (not shown) received from external entities detailing actual costs and dates associated with a service rendered. Other documentation (not shown) may also be stored by the system in PDF or image formats, in example, signed declarations from a donor to transfer ownership of their vehicles to an external entity upon donation or signed transfer documents upon a sale of a donated item. These documents stored in the system are typically only accessible by the central support center; furthermore, these documents may remain in the system for at least three years after a record has been closed or completed.

Vehicle at donor address 336 is used to identify the physical address of the vehicle to be donated. If the vehicle donation address is different from the donor address, the system may be able to record a secondary physical vehicle address (not shown) to identify the physical location of the vehicle. Vehicle pickup information 378 may be used by the selling entity 380 or the product delivery company 382. The selling entity 380 is responsible for selling of the vehicle. The product delivery company 382 or tow company may be responsible for picking up the donation from a donor provided address. The product delivery company 382 contact information (not shown) is captured by the system. Also, a pickup date 384 may be captured by the system, and a last pickup slip view date 386 may be captured by the system.

Moreover, transactions 387, including monetary transactions, may be captured by the system. Each transaction captured by the system may be described by a transaction number 393; a transaction description 394; a transaction amount 396; and a transaction pay date 397. A transaction may be posted to the system every-time a fee or a credit is identified. The system may be configured to support payment acceptance and delivery by credit card, check, cash, wire transfer, direct deposit. FIG. 3 illustrates an exemplary embodiment of a plurality of transactions associated with a single automobile donation record. These transactions are described as fallows: a first transaction 388 identifies a transaction number 393 of “1000,” a product description 394 of “Sale of Product,” identifies the amount 396 of “$325.00” and a pay date 397 of “3/21/2007.” The first transaction 388 describes the actual sale price of an automobile as sold to a new owner by an external selling entity. A second transaction 389 identifies a transaction number 393 of “1001,” a product description 394 of “Transportation Costs,” a transaction amount 396 of “$25.00,” and a post date 397 of “3/21/2007.” The second transaction 389 describes an expense associated with pick-up and delivery of an automobile from the donor to the external selling entity. This expense reduces the amount of net revenue that a charitable organization receives for the sale of an automobile. A third transaction 390 identifies a transaction number 393 of “1002,” a product description 394 of “Sale Fee,” a transaction amount 396 of “$25.00,” and a post date 397 of “3/21/2007.” The third transaction 390 describes the expense associated with using an external selling entity to facilitate the sale of the automobile. This expense also reduces the amount of net revenue that a charitable organization receives for the sale of an automobile. A fourth transaction 391 identifies a transaction number 393 of “1003,” a product description 394 of “Beneficiary Revenue,” a transaction amount 396 of “$70.00,” and a post date 397 of “3/21/2007.” The fourth transaction 391 describes the net revenue received by a beneficiary charitable organization calculated by the actual selling price of an automobile less any expenses associated with the selling an automobile. A fifth transaction 392 identifies a transaction number 393 of “1004,” a product description 394 of “Product Resale System Fee,” a transaction amount 396 of “$30.00,” and a post date 397 of “3/21/2007.” The fifth transaction 392 describes the expense associated with selling the automobile through a charitable auto donation system. This expense also reduces the amount of net revenue that a charitable organization receives for the sale of an automobile. The balance or total 398 as shown is “$0.00.”

The system may be capable of sending custom reports 301 to a donor, a beneficiary organization, or anyone having access to the record information stored by the system. The system may also be configured to generate custom reports 301 as needed by each entity involved in the car donation process. Such reports can include selected data from the database, which may be then formatted by predetermined criteria specific to each entity so that it can be printed out or imported, using a specified format, into other software (e.g., accounting software). This customization feature allows the system to be capable of displaying and sharing car donation information, eliminating the need to double enter the information into an external software application used by an external entity or charitable organization.

Moreover, the system may be configured to automatically fill in appropriate tax forms 399, for example 1098C, for donors. Tax forms 399 are sent electronically to any entity requesting to view the information once the automobile donation has been sold and all the accounting is complete. Also, the system may be configured to generate a donor “thank you” letter 303. The tax forms 399 and the “thank you” letter 303 are capable of being sent to the donor for tax deduction purposes. Automobile donation record 300 may be viewed by a plurality of external entities; each assigned a member name 306 and customized access with different permission settings to different modules supported within the system.

The system may be configured to support product resale procedures in a plurality of countries. For example, donations may be acquired in one country and sold in another country. Moreover, charitable organization from a plurality of different countries may use the system within their respective country to facilitate a fund raising effort by acquiring products from donation and selling these products to raise monetary funds for their organization. The system is capable of storing donation and sale information related to a re-sale of a product in a plurality of different counties.

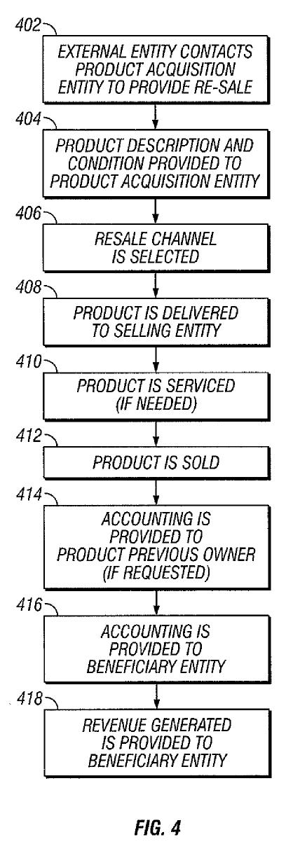

FIG. 4 illustrates a flow diagram of an exemplary method described in accordance with one embodiment of the invention. In step 402, an external entity, for example, an automobile donor, contacts a product acquisition entity, for example, a central support center, to provide a product for resale. In addition, the donor receives a tax benefit for utilizing the central support center to process the donation. The revenue generated from the resale of the donation may be provided to a beneficiary entity, in example, a charitable organization. In step 404, the external entity provides a product description and condition information to a product acquisition entity. In this step, the donor in communication with the central support center provides detailed information regarding the item to be donated for the benefit of charity. Before acquisition, the product may be evaluated for resale. The evaluation process may be required to decide whether the product to be acquired will eventually earn a positive net value for all entitles involved in the resale process. In step 406, a re-sale channel may be selected. After careful consideration of the estimated value of the donation, a resale channel may be selected that is best suited for maximum net revenue to the charitable organization. In step 408, the product is delivered to a selling entity. The product or item is typically acquired from the original owner and delivered to a location where the item will eventually be sold. In step 410, the product is serviced, if needed. This step is typically elected if it is determined that a donation may generate a higher margin of profit if it is re-conditioned or serviced before a sale. In step 412, the product is sold. Donated items are sold by a selling entity to a new owner in this step. In step, 414, accounting is provided to product previous owner, if requested. If the products' previous owner requests this service, tax and sale information may be sent to the products' previous owner for verification and validation of the sale of the donated item for the benefit of charity. In step 416, accounting is provided to the beneficiary entity. In this step, the beneficiary entity can be provided permission to access information in the system and receives tax and sales records verifying and validating the sale of a donated item. In step 418, revenue generated is provided to at least one beneficiary entity. In this step, the balance after expenses may be transferred to the beneficiary charitable organization.

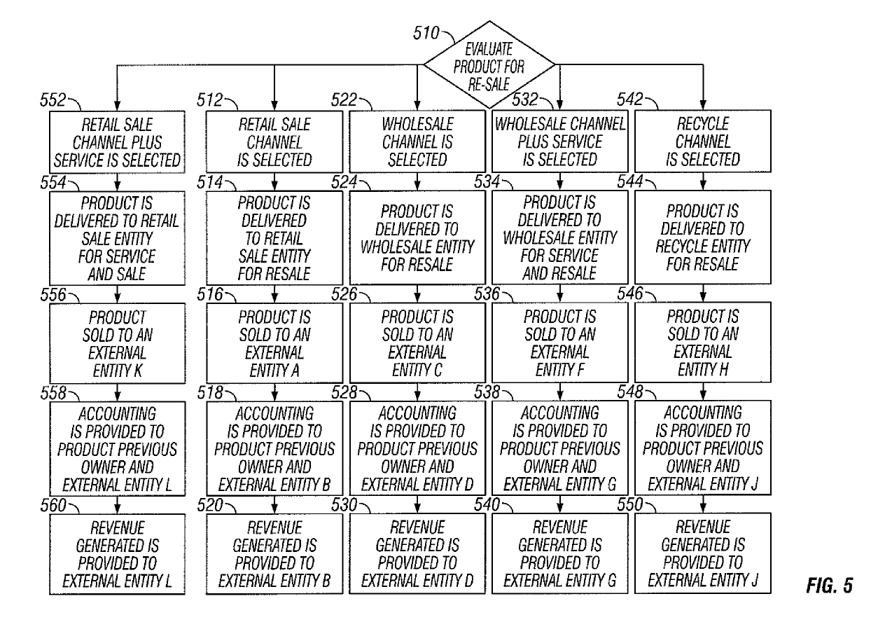

FIG. 5 illustrates a low level flow diagram of an exemplary method described in accordance with one embodiment of the invention. In step 510, a product is evaluated for re-sale, where a plurality of re-sale channels may be available to the product. At least one sale channel is selected to facilitate the actual selling of the product. In step 512, a retail sale channel may be selected, wherein a retail sale channel may be an automobile dealership or an online auto sales retailer. In step 514, a product, for example, an automobile, may be delivered to a retail sales entity for resale. In step 516, a product may be sold to an external entity A; for example, an automobile may be sold to a new owner. In step 518, accounting may be provided to product's previous owner, for example, a donor, and an external entity B, for example, a beneficiary charitable organization. In step 520, revenue generated may be provided to external entity B, for example, a beneficiary charitable organization.

In step 552, a retail sale channel plus service may be selected, wherein a retail sale channel may be an automobile dealership or an online auto sales retailer. In step 554, a product, for example, an automobile, may be delivered to retail sales entity for service and resale. In step 556, a product may be sold to an external entity K; for example, an automobile may be sold to a new owner. In step 558, accounting may be provided to product's previous owner, for example, a donor, and an external entity L, for example, a beneficiary charitable organization. In step 560, revenue generated may be provided to external entity L, for example, a beneficiary charitable organization.

In step 522, a wholesale channel may be selected, wherein a wholesale channel may be an automobile auction house. In step 524, a product, for example an automobile, may be delivered to wholesales entity location for resale. In step 526, a product may be sold to an external entity C; for example, an automobile may be sold to a new owner. In step 528, accounting may be provided to product's previous owner, for example, a donor, and an external entity D, for example, a beneficiary charitable organization. In step 530, revenue generated may be provided to external entity D, for example, a beneficiary charitable organization.

In step 532, a wholesale chancel plus service may be selected, wherein a wholesale channel may be an automobile auction house and servicing may be provided by a mechanic shop or automobile repair facility. In step 534, a product, for example an automobile, may be delivered to wholesales entity location for servicing and resale. In step 536, a product may be sold to an external entity F; for example, an automobile may be sold to a new owner. In step 538, accounting may be provided to product's previous owner, for example, a donor, and an external entity G, for example, a beneficiary charitable organization. In step 540, revenue generated may be provided to external entity G, for example, a beneficiary charitable organization.

In step 542, a recycle channel may be selected, wherein a recycle channel may be a automobile junk yard. In step 544, a product, for example an automobile, may be delivered to recycling entity location for resale. In step 546, a product may be sold to a recycling entity H; for example, an automobile may be sold to a junk yard owner. In step 548, accounting may be provided to product's previous owner, for example, a donor, and an external entity J, for example, a beneficiary charitable organization. In step 550, revenue generated may be provided to external entity G, for example, a beneficiary charitable organization.

Remotely located computers may request access of the system, such computers include cell phones, personal computers, server systems, laptop computers, PDA's and all types of mobile personal and business communication devices. The server computer system may include software modules that may reside in RAM memory, flash memory, ROM memory, EPROM memory, EEPROM memory, registers, hard disk, a removable disk, a CD-ROM, a RAID, or any other form of storage medium known in the art. An exemplary storage medium may be coupled to the processor such that the processor can read information from, and write information to, the storage medium. In the alternative, the storage medium may be integral to the processor. The processor and the storage medium may reside in an Application Specific Integrated Circuit (ASIC). In the alternative, the processor and the storage medium may reside as discrete components in the system.

In addition, the various illustrative functionality, database, and components described in connection with the embodiments disclosed herein (e.g., server computer 104 FIG. 1) may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a plurality of microprocessors, or any other such configuration.

All of the processes described above may be embodied in and fully automated via, software code modules executed by one or more general purpose computers. The code modules may be stored in any type of computer-readable medium or other computer storage device. Some or all of the methods may alternatively be embodied in specialized computer hardware. As will be apparent, the features and attributes of the specific embodiments disclosed above may be combined in different ways to form additional embodiments, all of which fall within the scope of the present disclosure.

Although this invention has been described in terms of certain preferred embodiments and applications, other embodiments and applications that are apparent to those of ordinary skill in the art, including embodiments which do not provide all of the features and advantages set forth herein, and also within the scope of this invention. Accordingly, the scope of the present invention is intended to be defined only by reference to the appended claims.

What is claimed is:

1. A method of processing an item for a charitable donation, the method comprising:
generating a plurality of donation data relating to a donated item, said plurality of donation data comprising at least one charitable organization to receive a benefit of said donated item;
associating a monetary value with said item;
determining at least one expense data related to selling said item, said plurality of donation data comprising said at least one expense data and said monetary value; and
providing said charitable organization access to said plurality of donation data including said monetary value and said at least one expense data, wherein a plurality of item transactions are accessible by said charitable organization.

2. The method of claim 1, further comprising selling said item, wherein said monetary value is determined by selling said donated item.

3. The method of claim 1, wherein said donated item is sold at an auction.

4. The method of claim 1, wherein said expense data comprises expenditures for preparing said item for sale.

5. The method of claim 1, wherein said donated item is an automobile.

6. The method of claim 1, wherein said benefit of said item is equal to said sale price of said item less at least one expenditure associated with the sale of said donated item.

7. The method of claim 1, wherein said charitable organization is provided access to said donation data using a webpage utilizing a username and a password determined for said charitable organization, wherein said provided access allows the charitable organization the ability to view said plurality of said item transactions for said at least one items for charitable donation of which said benefit is received.

8. A machine readable medium comprising instructions for processing a charitable donation, wherein the instructions upon execution cause a machine to:
track a status of at least one item for charitable donation;
generate a plurality of donation data relating to said item, said plurality of donation data comprising at least one charitable organization to receive a benefit of said item;
associate a monetary value with said item;
associate at least one expense data relating to selling said item, wherein said plurality of donation data comprising said at least one expense data and said monetary value; and
provide said charitable organization access to said plurality of donation data including said monetary value and said at least one expense data, wherein a plurality of item transactions are accessible by said charitable organization.

9. The machine readable medium of claim 8, further comprising selling said item, wherein said monetary value is determined by selling said item.

10. The machine readable medium of claim 8, wherein said item is an automobile sold at an auction.

11. The machine readable medium of claim 8, wherein said at least one expense data comprises expenditures for preparing said item for sale.

12. The machine readable medium of claim 8, wherein said benefit of said item is equal to said sale price of said item less at least one expenditure associated with the sale of said donated item.

13. The machine readable medium of claim 8, wherein said charitable organization is provided access to a portion of said plurality of donation data using a webpage accessible by utilizing a username and a password determined for said charitable organization, wherein said provided access allows the charitable organization to view accounting for donated items for which they receive said benefit.

14. A system for facilitating transactional and accounting related to a charitable donation that allows transparency to the charitable organization to view such transactions and accounting, the system comprising:
a storage medium to store information; and
an application logic executing on a processor configured to provide at least one charitable organization access to examine a plurality of transaction data comprising at least one expense for selling at least one donated item, a sales price of said at least one donated item and a status of said at least one donated item, said at least one donated item being designated to said at least one charitable organization.

15. The system of claim 14, wherein said at least one expense for selling a donated item is a sale fee.

16. The system of claim 14, wherein said donated item is an automobile.

17. The system of claim 14, wherein said status of said donated item is used to determine said donated item state in said system.

18. The system of claim 14, further comprising a username and a password used to access said system from a remote computer.

19. The system of claim 14, wherein said sale price less said at least one expense of said at least one donated item is used to determine a net sale revenue being designated to said at least one charitable organization.

20. The system of claim 14, wherein said at least one expense of said at least one donated item is an item delivery fee.

21. A machine readable medium comprising instructions for processing an item for resale, where the instructions upon execution cause a machine to:
receive at least one item information regarding at least one item for resale from a first entity;
monitor a status of said item for resale;
identify a second entity for processing said item for resale;
updating said status of said at least one item for resale based at least in part on the processing of said item for resale;
maintaining data relating to a sale of said at least one item for resale; and
providing access to said at least one item information received from a first entity.

22. The computer readable medium of claim 21, wherein said first entity and said second entity are granted permission to modify data in said system.

23. The computer readable medium of claim 21, wherein said first entity and second entity are allowed access using a web interface to view and modify said at least one item information maintained by the system.

24. The computer readable medium of claim 21, further comprising a third entity assigned to receive a monetary benefit related to said sale of said at least one item for resale.
